(19) United States
(12) Patent Application Publication
(10) Pub. No.: US 2008/0239498 A1
(43) Pub. Date: Oct. 2, 2008

(54) RANDOM PHASE MASK FOR LIGHT PIPE HOMOGENIZER

(76) Inventor: Meritt W. Reynolds, Burnaby (CA)

Correspondence Address: David A. Novais;Patent Legal Staff, Eastman Kodak Company, 343 State Street, Rochester, NY, 14650-2201, US

(21) Appl. No.: 11/690,931

(22) Filed: Mar. 26, 2007

(51) Int. Cl. G02B 27/10; G01N 37/00

(52) U.S. Cl. 359/618; 702/82

(57) ABSTRACT

An apparatus for illuminating a light valve (34) comprises at least one laser array (10) capable of emitting a plurality of radiation beams (40a, 40b, 40c), each radiation beam propagating along a first axis. A light pipe (20) comprises at least two reflecting surfaces being spaced apart and opposing each other to reflect light along the first axis. An input end (24) separation between the two planar reflecting surfaces (22) is positioned to receive the plurality of radiation beams. An output end (26) separation between the two reflecting surfaces is positioned to emit an output radiation (42b). At least one optical element is located downstream of the output end separation and is operable for illuminating the light valve by imaging a portion of the output radiation onto the light valve. A random phase mask (150) is operable for creating a substantially uniform illumination profile in the output radiation.

### CROSS-REFERENCE TO RELATED APPLICATIONS

This application is related to U.S. Ser. No. 60/539,336, entitled LINE ILLUMINATION OF LIGHT VALVES, filed Jan. 28, 2004 in the name of Reynolds et al.; and U.S. Ser. No. 11/038,188, entitled LINE ILLUMINATION OF LIGHT VALVES, filed Jan. 21, 2005 in the name of Reynolds et al., the disclosures of which are incorporated herein.

### FIELD OF THE INVENTION

This invention relates to the field of laser illumination and more particularly to producing illumination lines for use in imaging applications.

### BACKGROUND OF THE INVENTION

For various applications it is desirable to generate high uniform brightness illumination. To accomplish this without a large expenditure of power, or an excessive generation of heat, super luminescent emitters or lasers sources are typically used. When high levels of optical power, are required extended sources must be used to limit the power density in the source. For example, material processing applications may make use of suitably coupled diode laser radiation to change the nature or character of a work-piece. High powered laser-diode arrays have been used in the graphic arts to generate one-dimensional line illumination of a spatial light modulator for the transfer of information to printing plates. For applications relating to projection displays, area illuminators are desirable, and as such, various two-dimensional laser arrays have been proposed in the art.

In one particular imaging application, an array of laser diode emitters may be used to illuminate a multi-channel light valve. A light valve generally has a plurality of individually addressable modulator sites; each site producing a beam or channel of image-wise modulated light. An image is formed by selectively activating the channels while scanning them over an imageable media.

Laser diode arrays having nineteen or more 150 μm emitters are now available with total power output of around 50 W at a wavelength of 830 nm. While efforts are constantly underway to provide higher power, material and fabrication techniques still limit the power that can be achieved for any given configuration. In order to provide illumination lines with total power in the region of 100 W, an optical system designer may only be left with the option of combining the radiation from a plurality of laser diode arrays. Dual laser array combinations are disclosed in U.S. Pat. No. 5,900,981 (Oren et al.) and U.S. Pat. No. 6,064,528 (Simpson).

U.S. Pat. No. 5,517,359 (Gelbart) describes a method for imaging the radiation from a laser diode array having multiple emitters onto a linear light valve. The optical system superimposes the radiation line from each emitter at the plane of the light valve, thus forming a single combined illumination line. The superimposition provides some immunity from emitter failures (either partial or full). In the event of such a failure, while the output power is reduced, the uniformity of the line may not be severely impacted.

To increase the brightness of the uniform illumination, laser arrays are being used with integrating bars. U.S. Pat. No. 6,137,631 (Moulin) describes a means for mixing the radiant energy from a plurality of emitters on a laser diode array. U.S. Application Publication No. U.S. 2005/0175285 A1 (Reynolds et al.) describes the use of a plurality of reflecting surface positioned downstream from a plurality of laser diode arrays. The mixing means comprises a plurality of reflecting surfaces placed at or downstream from a point where the laser radiation has been focused. The radiant energy entering the mixing means is subjected to multiple reflections, which makes the output distribution of the emerging radiant energy more uniform.

Especially for applications where the visual quality of the resulting illumination is important, the uniformity of the illumination must be high. Diode emitters are typically quasi-monochromatic and degradation of illumination uniformity by interference effects can easily become important. For example, if there is some degree of coherence across the extended source, then the illumination can become non-uniform due to optical interference. Interference usually manifests itself in the illumination as ripple, which can be noticeable even if the ripple is of low amplitude. Interference effects can be reduced by making the elements of the source array incoherent with respect to one another. This can sometimes be accomplished by making the spacing of the array sufficiently large, but with possible loss of brightness. Alternately, in the case of a one dimensional array, it is possible to introduce an out-of-plane staggering to promote incoherence without a significant loss of brightness as taught in U.S. Pat. No. 4,786,918 (Thornton et al.).

For a quasi-monochromatic illumination system to suffer from interference, it is enough that the effective spatially extended source, as perceived from the surface being illuminated, appears to have coherence between its various parts. This coherence can arise when the source parts actually do have a degree of mutual coherence, or when light arrives at a given illuminated point from a particular source via multiple paths. For example, in the case where an integrating bar is used, an apparent source made up of a kaleidoscopic ensemble of images surrounding the actual source is created. These images are coherent with each other and with the actual source even if the source has no internal coherence. In both cases light from a given point on the source arrives at a given point on the illuminated surface by multiple paths. Consequently, even if the source has no intrinsic transverse coherence, interference effects will be present in the illumination if a light pipe is interposed between the source and the illuminated surface.

Conventional methods have attempted to reduce interference effects resulting from a single light source in a number of different manners including reducing the coherence of the source. An example of such a method is disclosed on U.S. Pat. No. 4,521,075 (Obenschain et al.) in which an echelon-like grating breaks a laser beam up into a number of differently delayed beamlets with delay increments larger than the coherence time of the beam. The beamlets can then be used as a source of reduced coherence.

U.S. Pat. No. 4,744,615 (Fan et al.) describes a system for transforming a coherent laser beam having a possibly non-uniform spatial intensity distribution into an incoherent light beam having substantially uniform spatial intensity distribution by homogenizing the laser beam with a light tunnel. The aspect ratio of the light tunnel is chosen so that the various paths from the laser to the illuminated surface differ by some length. A retardation plate is placed on either side of the tunnel to reduce the effective or equivalent coherence length of the laser light being homogenized by the tunnel. Each region of the retardation plate has a height or thickness which is different from all of its neighbors by no amount less than step size ho. U.S. Pat. No. 4,744,615 teaches that the coherence length seen by the light tunnel can be reduced to zero by employing a step size ho which is equal to the actual coherence length of the laser light divided by n−1, wherein n is the refractive index of the material of the plate.

U.S. Pat. No. 5,224,200 (Rasmussen et al.) describes the use of a laser beam homogenizer and a coherence delay line to separate a coherent input beam into several components each having a path length difference equal to a multiple of the coherence length with respect to the other components. The components recombine incoherently at the output of the homogenizer.

U.S. Pat. No. 6,950,454 (Kruschwitz et al.) describes that individual single-mode coherent organic lasers can be used with an integrator by including an element that reduces spatial coherence such as a diffuser. U.S. Pat. No. 6,950,454 describes that the diffuser should be rotated or vibrated in the optical paths between the organic laser array and the integrator optics in order to average out speckle induced by the optically rough diffuser surface.

U.S. Pat. No. 6,781,691 (MacKinnon et al.) describes the use of a light mixing system which comprises a light pipe and a directional diffuser such as a holographic optical diffuser to mix a spectrally selected beam downstream from a reflective spatial light modulator.

U.S. Pat. No. 6,347,176 (Hawryluk et al.) describes a light tunnel apparatus in which the effects of standing wave patterns by actively shifting the boundaries of the light tunnel using and acousto-optic modulator.

Additional new problems are created with the introduction of light pipes or integrating bars into illumination systems comprising one or more multi-source arrays (such as laser diode arrays). One such problem is the formation of sharp features in the illumination profile even when the elements of the array are mutually incoherent. These sharp features can arise when arrays of quasi-monochromatic sources are employed. The appearance of the sharp features (shown as features 100) is exemplified in FIG. 4 which simulates the final illumination profile at the end of an integration bar illuminated by a pair of diode arrays. These sharp features 100 or “scars” are deleterious to achieving a high degree uniform illumination profile.

There is a need for an apparatus and method for reducing the presence of non-uniformity in the illumination profile of illumination systems that employ a plurality of reflecting surfaces to mix beams of light emitted by a multi-source array.

### SUMMARY OF THE INVENTION

Briefly, according to one aspect of the present invention an apparatus for illuminating a light valve comprises at least one laser array capable of emitting a plurality of radiation beams, each radiation beam propagating along a first axis. A light pipe comprises at least two reflecting surfaces being spaced apart and opposing each other to reflect light along the first axis. An input end separation between the two planar reflecting surfaces is positioned to receive the plurality of radiation beams. An output end separation between the two reflecting surfaces is positioned to emit an output radiation. At least one optical element is located downstream of the output end separation and is operable for illuminating the light valve by imaging a portion of the output radiation onto the light valve. A random phase mask is operable for creating a substantially uniform illumination profile in the output radiation.

### BRIEF DESCRIPTION OF THE DRAWINGS

FIG. 1 shows a conventional illumination system in which radiation from one or more laser arrays is directed onto an integrating bar or light pipe;

FIG. 2A shows a systems plane view of the conventional illumination system of FIG. 1;

FIG. 2B shows a view perpendicular to the systems plane of the conventional illumination system of FIG. 1;

FIG. 3 schematically shows an interaction of radiation beams with a conventional light pipe;

FIG. 4 shows a computer simulation showing the appearance of sharp features in the illumination profile of a conventional illumination system employing a light pipe;

FIG. 5 schematically shows a mechanism for the formation of sharp features in an illumination profile by showing the interaction of a regular array of sources next to a mirror surface;

FIG. 6 schematically shows a mechanism for the reduction of a characteristic size of sharp features by showing a the interaction of point sources with a mirror surface as a function of the distance between the sources and the mirror surface;

FIG. 7 shows one embodiment of the invention as an illumination system, a light pipe, and a random phase mask;

FIG. 8 shows a 1-D random phase mask as per an example embodiment of the invention;

FIG. 9 shows a computer simulation showing reduction of sharp features in the illumination profile of an illumination system employing a light pipe and a random phase mask; and

FIG. 10 shows an illumination system as per an example embodiment of the invention in which a random phase mask is positioned within a light pipe of the illumination system.

### DETAILED DESCRIPTION OF THE INVENTION

The invention has been described in detail with particular reference to certain example embodiments thereof, but it will be understood that variations and modifications can be effected within the spirit and scope of the invention.

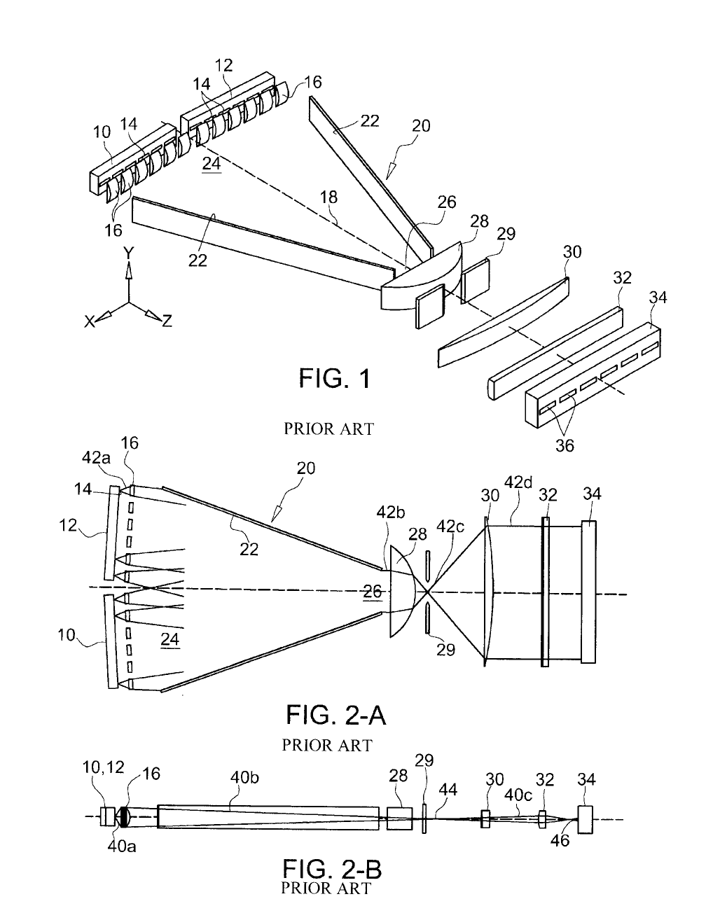

FIG. 1 shows a conventional illumination system in which radiation from one or more laser arrays is directed onto an integrating bar or light pipe 20. In this system two laser arrays 10 and 12 are employed. Other systems employing a single array are known in the art. Light pipe 20 is defined by a pair of reflecting surfaces 22 that are substantially perpendicular to the system plane. The system plane is defined as the plane that is parallel to the XZ plane. Light pipe 20 includes an input end 24 and an output end 26. In this illustrated system, the reflecting surfaces 22 are not parallel to one another. In other conventional systems, the reflecting surfaces 22 can be parallel to one another especially if the emitters of the arrays are highly divergent and/or if there is sufficient space to allow a longer light pipe. Non-parallel reflecting surfaces can be selected to suit a number of factors including the slow axis divergence of the laser emitters, the size of laser arrays and their orientation with respect to axis 18, and any physical constraints on the length of the light pipe.

Each of the laser arrays 10 and 12 can comprise a laser diode array, each array which has a plurality of emitters 14. Emitters 14 are sometimes referred to as stripe emitters since they are very narrow (typically 1 μm) in one direction and elongated (typically greater than 80 μm for a multimode laser) in the other direction. Usually, the elongated sides of the emitter stripes lie in the system plane. In this case, the Y axis is commonly referred to as the “fast axis” since the laser radiation diverges very quickly in that direction, and the X axis is commonly referred to as the “slow axis” since the laser radiation diverges comparatively slowly in that direction (around 8° included angle divergence in the slow axis compared to around 30° included angle divergence for the fast axis). In the illustrated system, each emitter 14 in each of the laser arrays 10 and 12 produces an output beam that is single transverse mode in the fast axis and multiple transverse modes in the slow axis. In this conventional system, a microlens 16 is positioned in front of each emitter 14 in order to gather the radiation from emitters 14. Microlenses 16 can be sliced from circular aspheric lens using a pair of spaced apart diamond saw blades as described in commonly assigned U.S. Pat. No. 5,861,992 (Gelbart). Other microlens elements may also be used such as the monolithic micro-optical arrays produced by Lissotschenko Mikrooptik (LIMO) GmbH of Dortmund, Germany. LIMO produces a range of fast axis and slow axis collimators that may be used alone or in combination to format the radiation from laser diode arrays.

Referring back to FIG. 1, the output end 26 of light pipe 20 is optically coupled by lenses 28, 30 and 32 onto a light valve 34, thereby allowing the output end 26 to be imaged onto light valve 34. Light valve 34 has a plurality of modulator sites 36. An aperture stop 29 is placed between lenses 28 and 30. The modulator sites 36 of light valve 34 may be imaged onto an intended target using an optical imaging system (not shown). Light valve 34 is shown as a one dimensional array in FIGS. 2A and 2B. In other example embodiments of the invention, light valves consisting of a two dimensional array of individually operable pixels arranged in a rectangle can be used in applications such as displays. An example of a one dimensional light valve is Grating Light Valve™ “GLV” produced by Silicon Light Machines of San Jose, Calif., U.S.A. An example of a two dimensional light valve is DMD Discovery™, a digital Micromirror Device “DMD” produced by Texas Instruments Incorporated.

In the case of multiple diode arrays as shown in FIG. 1, the laser arrays 10 and 12 can be “toed-in” slightly to towards central axis 18. Alternatively, the toe-in can be accomplished optically using a cylindrical lens (not shown) having power in the system plane. The cylindrical lens would typically be located between microlenses 16 and the light pipe input end 24.

The operation of the conventional illumination system is described in relation to FIG. 1, FIG. 2A and FIG. 2B. In the system shown, radiation from the emitters 14 is astigmatic and an anamorphic imaging system is used to illuminate light valve 34. The propagation of radiation in the fast and slow axes should thus be considered separately.

In the system plane, shown in FIG. 2A, diverging radiation beams 42a from emitters 14 are gathered by microlenses 16 and directed into the input end 24 of light pipe 20. Microlenses 16 are aligned in the slow axis to aim the radiation beam 42a from each emitter 14 towards central axis 18. In this system, any specific radiation beam emitted by a corresponding emitter will, at the input end of the light pipe, not overlap in the slow scan direction with all of the other radiation beams emitted by all of the other emitters, regardless of whether the other emitters are part of the same laser array or any other laser array. The radiation beams can be focused to a common focal point downstream of input end 24. In other systems, each radiation beam from the one or more arrays can be focused to a common point at, or upstream of input end 24. In yet other systems, the radiation from the emitters of each laser array is collimated in the fast axis direction using a cylindrical lens immediately following the laser arrays.

In a plane perpendicular to the system plane, shown in FIG. 2B, the radiation beams 40a from emitters 14 diverge rapidly. It should be noted that each of radiation beams 40a and 42a represent the beams emitted from emitters 14 as observed in different planes. Each microlens 16 gathers the radiation 40a from an emitter 14 and focuses it to a waist at point 44. Point 44 is downstream of the output end 26 the light pipe 20 and is between lenses 28 and 30 in this system. The location for point 44 can be chosen to limit the power density on optical surfaces. The waist is imaged onto the light valve 34 by cylindrical lens 32. Alternatively, emitters 14 need not be focused to produce a waist before cylindrical lens 32 but rather, could produce a virtual waist after cylindrical lens 32. Cylindrical lens 32 can then image the virtual waist onto the light valve 34.

Returning to FIG. 1, microlenses 16 are aligned in the fast axis to locate the waist for each emitter 14 at point 44 in order to overlap the radiation contributions from each emitter 14 thus forming a composite waist at point 44.

Optical element 28 is a cylindrical lens having no optical power in the fast axis. Aperture 29 similarly has no effect on the fast axis propagation of the radiation. Element 30 is a spherical field lens. Element 32 is a cylindrical lens with optical power in the fast axis for focusing beams 40c into a narrow line 46 on light valve 34.

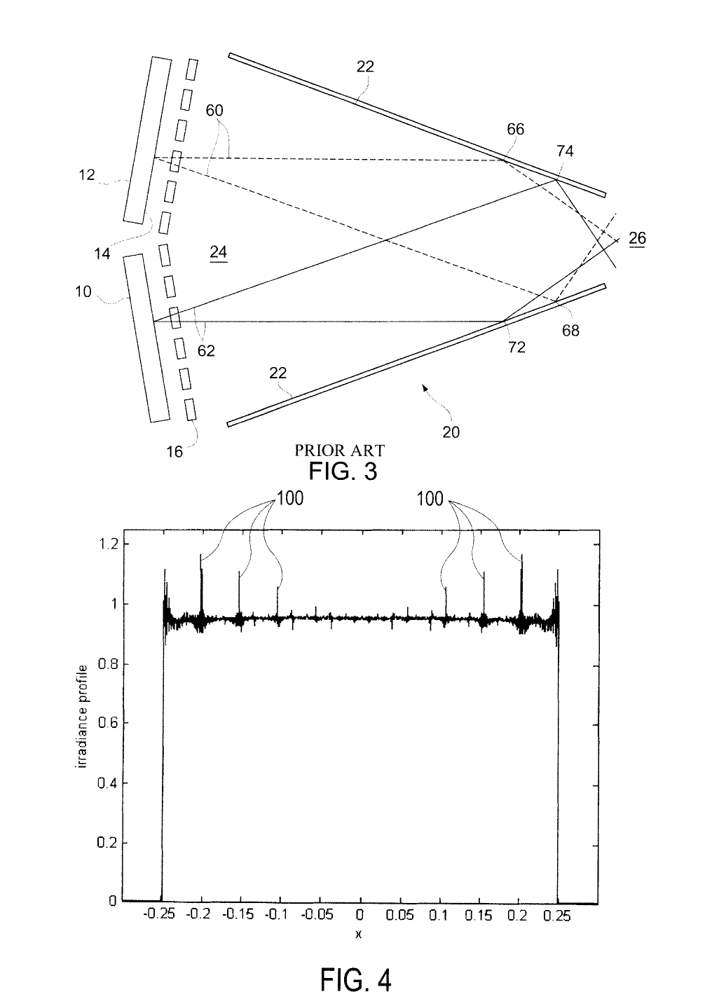

Light pipe 20 is used to combine and mix the radiation beams from emitters 14 on laser arrays 10 and 12 and produce an output radiation at the output end 26. The operation of the light pipe 20 is described in relation to FIG. 3. Emitters 14 produce radiation beams. Two representative beams 60 and 62 are shown in FIG. 3 although it should be understood that each emitter produces such a beam. Each of beams 60 and 62 should also be understood to include a bundle of rays within the bounds shown for the beam. It should also be further understood that the bounds represented by beams 60 and 62 are shown for the purposes of illustration only. Beam 60 is reflected at points 66 and 68 by reflective surfaces 22 before reaching the output end 26 of light pipe 20. Beam 62 is reflected at points 72 and 74 before reaching output end 26. At output end 26, beams 60 and 62 are overlapped and mixed to form part of an output radiation at output end 26. Beams from other emitters 14 can be similarly reflected before reaching output end 26. Output radiation at output end 26 will comprise an output composite radiation beam made up of a substantial portion (i.e. accounting for any minor losses in the light pipe 20) of each of the radiation beams emitted from emitters 14. The output radiation comprises a composite illumination line. This composite illumination line can be magnified by a suitable optical system to illuminate light valve 34. In the case of multi-array systems (as shown in FIGS. 2A and 2B) it should be noted that the plurality of radiation beams emitted from laser array 10 will produce a first illumination line and the plurality of radiation beams emitted from laser array 12 will produce a second illumination line. The first and second illumination lines may be spaced apart or at least partially overlapped at output end 26, but in either case they can form the composite illumination line. When spaced apart, the first and second illumination lines can be merged further downstream of the light pipe 20.

Referring back to FIGS. 2A and 2B, output end 26 is imaged onto light valve 34 by an optical system that can include cylindrical lens 28 and spherical lens 30. Output radiation beams 42b leaving the output end 26 are essentially telecentric and an aperture 29 is placed at the focus of lens 28. The function of the aperture 29 is to block outermost rays that may have undergone too many reflections in the light pipe, and consequently have too great an angle to axis 18 upon leaving output end 26. Such rays, if included may reduce the uniformity of composite illumination beam 42c, particularly at the edges. Spherical lens 30 is a field lens, which ensures that beams 42d illuminate light valve 34 telecentrically in the system plane. Telecentric illumination of a light valve helps to ensure that each modulator site is equivalently illuminated.

In some conventional systems, the reflective surfaces 22 of light pipe 20 may be selected for high reflectivity only for radiation polarized in the direction of the fast axis. Radiation that is polarized in other directions will be attenuated through the multiple reflections in light pipe 20. This is an advantage for some light valves that are only able to modulate beams that are polarized in a specific direction since beams having other polarization directions will be passed through the light valve un-attenuated thus reducing the achievable contrast.

In summary, the use of light pipe 20 scrambles the radiation beams from one or more multi-source laser arrays by the multiple reflections from reflective surfaces 22. The purpose of this scrambling is to attempt to produce a uniform illumination profile at output end 26. Applications where the visual quality of the resulting illumination is important require a high degree of uniformity in this profile. Although the system illustrated in FIG. 1 is effective in producing a composite profile with a high brightness, the present inventors have noted that non-conformities can still be present in the profile.

The present inventors have determined that when one or more arrays of quasi-monochromatic sources (e.g. laser diodes) are used in conjunction with a light pipe, a formation of “sharp” features in the illumination profile is created. This can occur even when the elements of the array are mutually incoherent. FIG. 4 represents a computer simulation showing the appearance of sharp features 100 in the illumination profile of a system similar to that shown in FIG. 1. In FIG. 4, the variable “x” corresponds to a position in dimensionless units. Output end 26 of the light pipe corresponds to −0.25<×<0.25. In the simulation, light pipe 20 is illuminated by a pair of laser diode bars, each bar made up of 19 emitters. Each emitter was modeled as contributing 24 mutually incoherent modes, a number consistent with known properties of a typical diode bar. It is to be noted that the average irradiance resulting in the simulation is less than 1 because the divergence of the light pipe output has been limited by an aperture stop. Various assumptions were made by the present inventors in this simulation. In particular, it was assumed that the mutually incoherent emitter modes were eigenmodes of a uniform waveguide and each emitter mode was given the same power. Nonetheless, the presence of sharp features 100 as predicted by this simulation were seen in experiment by the present inventors. The present invention has determined that the detailed shape of sharp features 100 typically depends on the internal structure and spectral characteristics of the source array, and on the position of the sources relative to the reflecting surfaces of light pipe 20. It has been further determined that these sharp features are typically very robust and cannot generally be blurred by defocusing. Sharp features 100 cannot typically be eliminated by imaging the illumination through an optical system with a poor modulation transfer function.

The present invention has discovered that if the multi-source array has a periodic structure, then the illumination profile at the output end of the light pipe exhibits sharp features 100. This is problem is typically unavoidable in many applications in which the preferred light source is a laser diode bar which consists of a periodic array of laser emitters. The present invention has determined that sharp features 100 are not due to interference between the light sources of the periodic array, and will occur even when the light sources are mutually incoherent. One possible explanation for the presence of sharp features 100 is that they are due to a Moire effect. Each emitter in the array produces at the output end of the light pipe an irradiance pattern consisting of fringes. These fringes are generated because of the interference between multiple reflections in light pipe 20 as opposed to interference effects associated with the sources themselves.

Without being limited to any particular theory, the present inventors believe that the spacing of the fringes depends on the position of the emitter with respect to a reflecting surface 22 of light pipe 20. The closer the emitter is to a reflecting surface 22, the larger the spacing of the fringes. When the emitters are positioned in a periodic manner, the fringes from all the emitters have the same phase for certain positions at the output end of the light pipe. This “synchronization” of the fringe patterns can produce sharp features 100.

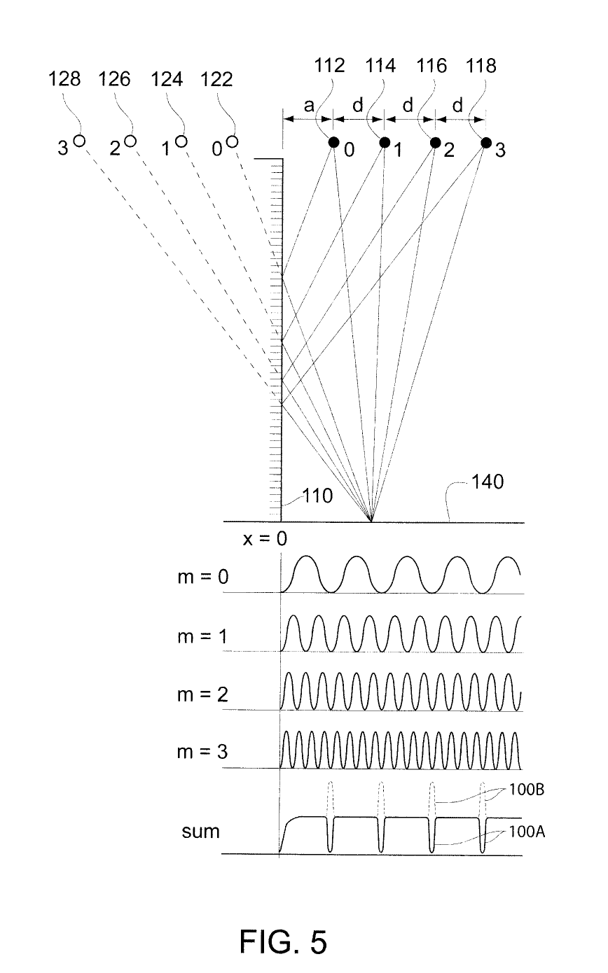

One may attempt to understand the formation of these sharp features 100 in the illumination profile by considering a regular array of mutually incoherent quasi-monochromatic point sources 112, 114, 116 and 118 next to a mirror 110 as shown in FIG. 5. It is understood that four point sources are shown for the purposes of illustration only and that this discussion is relevant to any suitable number of sources. Mirror 110 mimics one of the reflecting surfaces 22 of light pipe 20. Mirror 110 produces a virtual image 122, 124, 126 and 114 of each source, and each virtual image is incoherent with its original source. Consequently, the interference of reflected light from each source and its virtual image produces a fringe pattern on the illumination as shown in FIG. 5. This is model is known as a Lloyd's mirror interferometer. The spatial frequency of the interference pattern generated by the reflected light emitted by each of the sources 112, 114, 116 and 118 is proportional to the distance of the source from the plane of mirror 110. Since the sources 112, 114, 116 and 118 are mutually incoherent, the intensity profiles from each source add incoherently. This can produce a uniform illumination except where the interference patterns have the same phase for all sources. This can occur not only at the plane of mirror 110 but also at certain points away from this plane. These certain points exist because the source array is regular in nature. At each of these points a sharp feature 100 can develop as more sources are added. Because the intensity profiles add incoherently, the existence of the sharp features 100 should be understood as a Moire effect. The Moire effect is created by the effect of superimposing patterns of the same or different design to produce an overall pattern that is distinct from its components.

FIG. 5 shows that sharp features 100 can take the form of “trough-like” spikes in the illumination profile as indicated by trough sharp features 100A (shown in solid lines) or peaked spikes in the illumination profile show as shown by peak sharp features 100B ( shown in broken lines). The characteristics of sharp features 100 can typically depend on the spacing of the source array from the plane of the reflecting surface.

Mathematically, each of the point sources 112, 114, 116 and 118 next to mirror 110 generates an intensity profile on an illuminated surface 130 given by 2 sin²(k αₘ sinθ), where αₘ=α+md (the distance of the m′th source from the plane of mirror 110 (“a” corresponding to an initial offset and “d” corresponding to the pitch of the array). For the sake of simplicity, the Fraunhofer case is considered, and the illumination surface 140 is modeled to be “far” from the source array. The net intensity profile I(θ) can be given by the following sum:

I(θ)/Iₒ=4 sin²(ka sinθ)+4 sin²[k(α+d)sinθ]+4 sin²[k(α+2d)sinθ]+ (1)

where Iₒ is the intensity that would be produced on the illumination surface 130 by a single point source in the absence of mirror 110. Each term in this sum is the contribution of light from one of the point sources 112, 114, 116 and 118. In the limit where the number of sources N is large, the sum tends to a uniform value equal to 2 N at all angles θ, except where the phase of all terms in the sum is the same; that is, where kαsinθ is a multiple of π (making use of the identity 2 sin²x=1−cos 2×). At these particular angles the sum is somewhere between 0 and 4 N, depending on the distance a between the first source 112 and the plane of mirror 110. Experimentally, sharp features 100 are observed to have a small width, an oscillatory structure, and typically cannot be diminished by choice of phase. The existence sharp features 100 generated at positions predicted by these certain angles has been observable in practice. Another way to appreciate the formation of sharp features 100 is to realize that the sum of a Fourier series with equal amplitudes and frequencies in arithmetic progression is a comb, wherein the “teeth” of the comb correspond to sharp features 100. As shown in FIG. 5, trough sharp features 100A result from a coincidence of the minima of the various sinusoidal patterns. In other cases peak sharp features 100B would result from a coincidence of the maxima of the various sinusoidal patterns.

In an integrating bar or light pipe, there are typically multiple reflecting surfaces, but the basic theory is the same. By the incoherent superposition of interference patterns with spatial frequency in arithmetic progression, sharp features 100 are generated in an otherwise homogenized illumination.

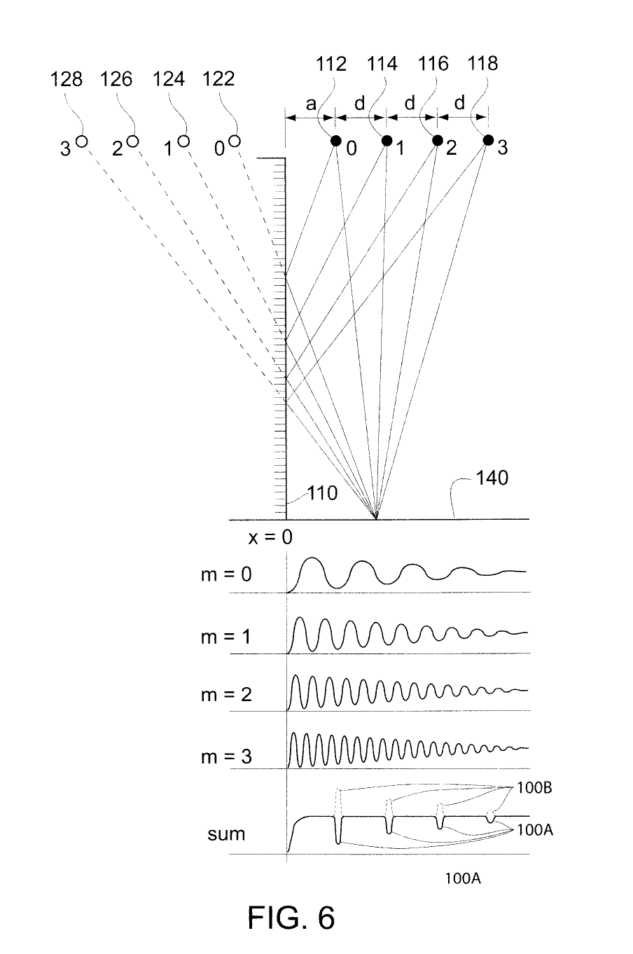

Referring back to FIG. 4, it is apparent that the sharp features 100 tend to be less pronounced, the further they are located from the reflecting surfaces of the light pipe. This is also observable in practice. One possible reason for this is the finite longitudinal coherence length of the elements of the source array. Considering the finite coherence length of the source elements of the array, the fringe contrast for each interference pattern diminishes further from the plane of mirror 110, as shown in FIG. 6. Consequently, the sharp features become less pronounced the further they are from the plane of the mirror. In some applications, however, coherence effects are expected to remain significant over an appreciable area of the illumination. For, example, in a system using a laser diode array with a wavelength, λ=820 nm and Δλ=4 nm, the coherence length, I_{c} can be determined by I_{c}=λ²/Δλ=0.17 mm. Coherence effects will persist until the angle is large enough that the path length differences satisfies 2α sinθ>I_{c}. For a distance α=1 mm, the characteristic angle is θ_{c}≈I_{c}/2α=0.085. This is significantly larger than the divergence of the source, which implies that the coherence effects are likely unavoidable in this configuration.

It is to be understood that other phenomenon may be responsible for this decrease in amplitude of sharp features 100. It is apparent however, that the amplitude of sharp features 100 may be reduced by positioning the source array as far away as possible from the plane of the reflecting surfaces 22 of light pipe 20. In this case, the series represented by equation (1) would start at a higher spatial frequency and sharp features 100 are typically less obtrusive. A loss of brightness would however typically accompany such an approach because an area of the input end 24 of light pipe 20 must remain dark, and this darkness can be mixed into the illumination by light pipe 20. This approach attempts to achieve uniform illumination by simply discarding light near the edges of light pipe 20. In this case, the cost of this uniformity is a reduction of the system efficiency, which is not conducive to a high throughput system required by many applications.

Since sharp features 100 are fundamentally due to the regular spacing of the source array, one way to eliminate them is to make the array of sources irregular. The sharp features 100 are however quite robust, and the required irregularity to eliminate them completely is typically quite large. This generally would require expensive customization of the source array and excessive complication of the overall system. Irregular laser diode arrays are not typically readily available.

The present inventors have observed that sharp features 100 do not appear to be eliminated by imaging the illumination through an aberrated imaging system. This may appear surprising. A common way to evaluate imaging systems is by measuring their modulation transfer function (MTF). For a system with poor MTF, one may expect that sharp features 100 would not be reproduced in the image. However, the sinusoidal patterns that sum incoherently to form sharp features 100 are themselves each due to the interference of just two waves (one from a point source and one from its image in the reflected surface). The contrast of such a two-wave interference is far less impacted by the MTF than is the image of a sinusoidal image test pattern

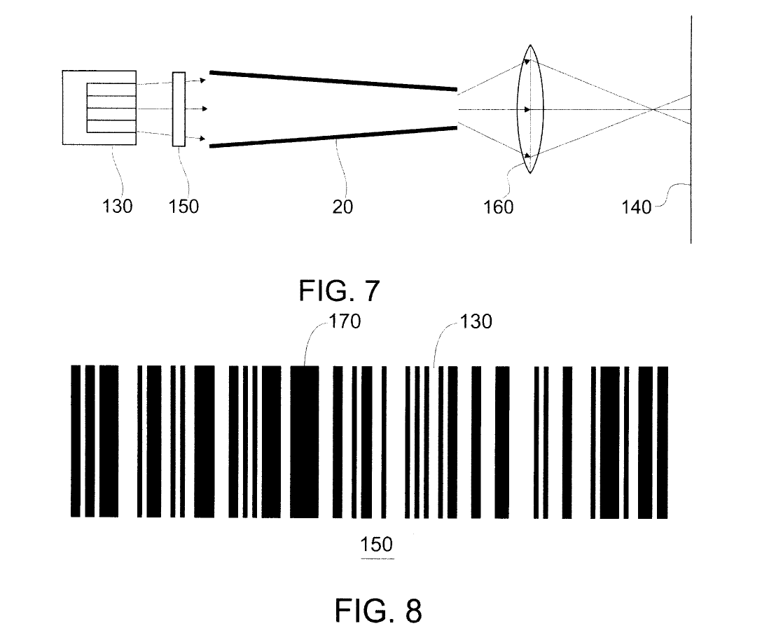

FIG. 7 shows a schematic top view of an example embodiment of the present invention that can be used to avoid illumination non-uniformities like sharp features 100 in systems wherein a light pipe 20 is used to mix light emitted by a regular multi-source array 130. Multi-source arrays 130 can include one dimensional (line) arrays and two dimensional (area) arrays. In one aspect of the present invention random phase mask 150 comprising areas of different optical thickness in a quasi-random or random arrangement is positioned between the multi-source array and an illuminated surface 140. Illuminated surface 140 can include a spatial modulator or light valve. The optical thickness difference is small, typically on the order a portion of a wave, and preferably about half a wave. Within each area, the optical thickness is preferably constant to help reduce a tendency to deflect the rays by refraction. A function of random phase mask 150 is that each ray passing through the phase mask acquires a phase shift depending on where the ray transverses the phase mask. The phase shift difference between any two rays will be zero or a portion of a wave, depending on where each ray intersects the surface. The quasi-random or random arrangement of phase shifts scrambles the phase information of light, resulting in a more uniform illumination substantially free of illumination non-uniformities like sharp features 100.

On pages 15-18 of Volume No. 1 of the ILE Quarterly Progress Report on Internal Fussion (May 1982 issue), Mima and Kata disclose the use of a random phase mask to reduce spatial coherence of a fusion laser. Mima and Kata state that when a laser beam with a large diameter is employed, it is very difficult to obtain uniform intensity distribution near the focal point and that this nonuniformity arises from the diffraction effect, liner aberrations in many optical elements and nonlinear aberrations due to the whole beam as well as the small scale defocusings. Mima and Kima propose the use of a random phase mask to eliminate the spatial coherence of the laser beam as a new approach to obtain a smooth absorption profile in the plasma. As taught by Mima and Kata, the random phase mask consists of a two dimensional array of square areas, each of which applies a phase shift between 0 and 2π radians to the incident light. Random phase masks have been additionally used to distribute light evenly over the recording plane of Fourier transform holograms as taught by Burkhardt in a paper entitled “Use of a Random Phase Mask for the Recording of Fourier Transform Holograms of Data Masks” published March 1970 in Volume 9, No. 3 of Applied Optics.

Random phase mask 150 reduces or substantially eliminates the sharp features 100 by making the phase of the rays a stochastic function of the direction in which the rays strike illuminated surface 140. In order to accomplish this, random phase mask 150 is placed somewhere between the multi-source array 130 and the illuminated surface 140, the phase mask introducing a phase shift that is a function of the position at which the rays strike the phase mask. Random phase mask 150 should not be place too closely to the multi-source array 130, or to the illuminated surface 140 such that the rays going directly to the illuminated surface 140 and the rays going to illuminated surface 140 via reflections within light pipe 20 are not sufficiently separated to sample different phase regions of random phase mask 150. Additional optical elements 160 may be present to format the size and divergence of the light at any point along the optical path. Random phase mask 150 need not be the final optical element before the illuminated surface 140. Random phase mask 150 need not be positioned downstream of light pipe 20. Additional optical elements may be present for various other purposes. For example, optical elements (not shown) may be positioned between multi-source array 130 and the input end of light pipe 20. In some embodiments of the invention, the additional optical elements can include at least one lens (e.g. a cylindrical lens). In some embodiments of the invention the additional optical elements can include an anamorphic optical element.

Random phase mask 150 can be manufactured from a uniform fused silica window by etching selected areas of its surface to a depth corresponding to desired phase shift amount. Using conventional techniques, it is possible to produce a plate on which the etched and un-etched areas are substantially flat and parallel and do not scatter the rays that pass through these areas. A preferred etch depth of the present invention corresponds to about a half wave phase shift (i.e. approximately π radians). An etch depth “t” required to obtain a half-wave phase shift can be estimated by the relationship: (n−1)t=λ/2, such that for a wavelength of λ=0.82 micron and a refractive index n=1.453, an etch depth t of 0.90 microns is required. The random phase mask 150 can be anti-reflection coated to reduce losses due to reflection at the surfaces. As will be obvious to those skilled in the related art, other techniques can be used to create a random phase mask.

To reduce parasitic diffraction losses, areas of substantially equal optical thickness should be larger than the wavelength of the light. Typically, it is preferred that the areas be at least about 10 times the wavelength of the light.

The pattern of different areas can be engineered. A one dimensional random phase mask can be modeled using a physical optics computer simulation. A Monte Carlo algorithm can be used to optimize the pattern by the principle of minimax to substantially maximize the illumination uniformity and efficiency for the system. A typical phase mask 150 designed for use with a 10 mm wide laser diode array is shown in FIG. 8. The pattern area of the plate is 13 mm wide. The smallest feature size is approximately 50 times the wavelength in width. In FIG. 8, shaded areas 170 indicate areas in which rays traversing the plate acquire a half-wave phase shift with respect to rays traversing the un-shaded areas 180. In reality the phase is transparent. Computer simulations typically indicate that a one half wave phase shift is preferred. Similar random phase masks designed this way have been manufactured and tested and are effective at eliminating sharp features 100 in the illumination profile.

Various design algorithms can be employed to create a random phase mask 150 suitable for reducing the presence of sharp features 100. The following process was employed to design a random phase mask 150 that was design to work with a beam of width W=20 mm and numerical aperture N.A.=0.026. The entendue of the beam was 0.26 mm. A goal of the design algorithm was to keep as much of the power as possible within this entendue.

The random phase mask 150 was designed by considering a uniform plate with a clear aperture of width W subdivided into N strips of equal width W/N. The phase shift associated with each strip was binary in that it could either be zero (i.e. a phase factor of +1) or one half a wave (i.e. a phase factor of −1). The random phase mask thus includes a phase-based mosaic pattern. An initial mosaic referred to as a “seed mosaic” M(0) was generated by choosing the sign of the phase factors randomly for each strip. From this seed mosaic, a sequence of mosaics M(1), M(2), M(3), . . . was generated, with each mosaic M(i+1) being derived from mosaic M(i) by flipping the sign of the phase factor of a randomly chosen strip. For each resulting random phase mosaic M(i), the intensity profile that would result at the end of a light pipe chosen by the system design was estimated by a Fourier optics calculation.

The Fourier optics calculation employed modeled the laser diode array as a plurality of emitters with incoherent electromagnetic modes. The size and divergence of the emitters dictated the effective number of transverse modes per emitter. During the simulation, 760 modes for the laser diode array in total were considered. Because of limited dimensionality, a scalar treatment was acceptable and the modes were represented by an electric field function E(x,z). Each mode was modeled as propagating down the light pipe 20 coherently by Fourier transforming E(x,0) to obtain the transverse momentum representation E(k,z); multiplying each component by the appropriate phase factor; then inverse Fourier transforming to find the electric field E(x,L) and thus the intensity profile I(x)=|E(x,1)|̂2. The intensity profile was smoothed by convolving it with a Gausian to further mimic experimental measurements.

The algorithm maintains track of the mosaic M(best) with the best associated intensity profile by employing the following method: Mosaic M(i) replaces M(best) if two criteria are met:

1) the smoothed profile at the end of the light pipe is more uniform for M(i) than for M(best); and

2) the power remaining within the etendue of the original beam exceeds 95%.

The above algorithm was repeated for several hundred iterations at which point further improvements in the results diminished. The optimization process was also repeated with different values of N ranging from 128 to 512, and with different seed mosaics. The optimization process was additionally accelerated by requiring the mosaic pattern to be symmetrical about the random phase mask centerline, thereby reducing the number of modeled strips to N/2. A reasonable maximum number of strips can be determined by the ratio of the etendue to the beam wavelength (about 300 in the design problem that was investigated by the present inventors).

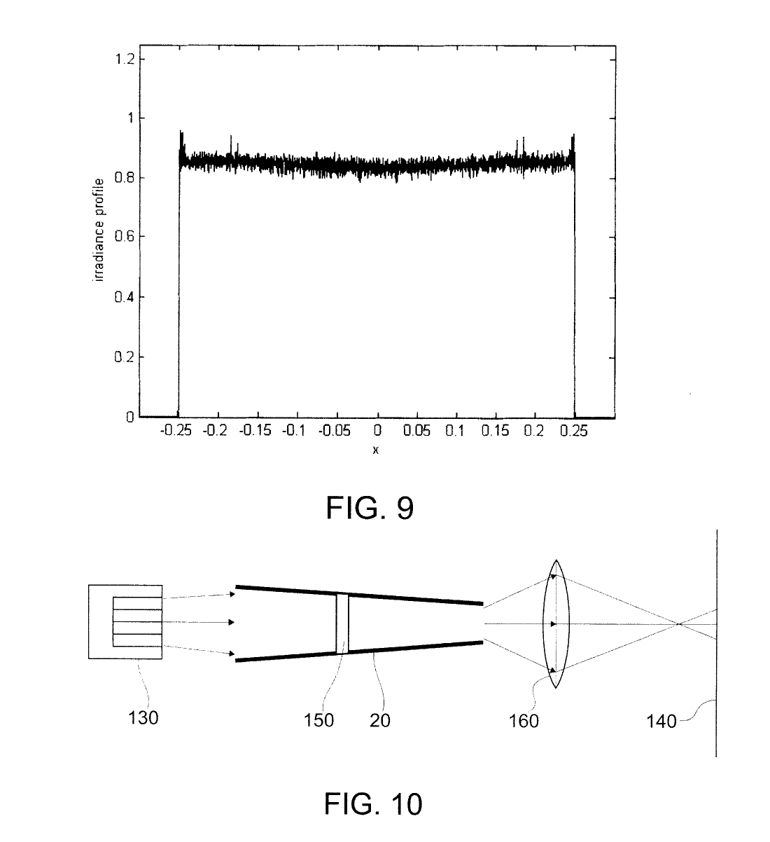

FIG. 9 represents a computer simulation showing a reduction of sharp features 100 in the illumination profile as per an example embodiment of the invention. FIG. 9 shows the computer simulation of the illumination profile t for the same light pipe and source array that was simulated in FIG. 4. However, FIG. 9 also models the effects associated with the addition of a random phase mask 150 positioned in the vicinity of the input end of the light pipe. FIG. 9 shows that the presence of sharp features 100 is effectively reduced and results in a substantially uniform illumination profile.

Additional computer simulations indicate that the random phase mask 150 may also be effective when designed for insertion within light pipe 120, which may be useful in some applications. This compact geometry is shown in FIG. 10.

It will be obvious to those skilled in the art that the random phase mask 150 can be integrated with other optical elements. By way of non-limiting example, the random phase mask 150 can be created on the surface of a refractive element such as a lens. It is also possible to produce a mirror which imposes phase shifts in a pattern. It is further obvious that random phase mask 150 can be constructed with more than two levels of phase shift.

In the embodiments described herein, radiation is formed into a narrow line at the light valve but this is not mandated. In general the radiation line is formatted to suit the light valve and the radiation may be spread over a wider area. Additionally while embodiments described herein show the lasers emitting in a common plane, the lasers could also be disposed to emit in a different plane. In this case the light pipe still mixes the beams in the slow axis direction, the combination of the beams in the fast axis occurring after the light pipe. For two dimensional or area illuminators, random phase mask patterns can be useful. Since parasitic diffraction losses can typically depend on the length of the perimeter between the areas of constant phase, a phase mask 150 with smooth, continuous edges is typically most efficient. Evaluation of such patterns is possible by physical optics simulation techniques using current computer technology.

It is noteworthy that the random phase mask is not a diffuser and does not work by diffraction. The random phase mask 150 functions by imparting a phase shift to light rays. The entire function can be understood in terms of ray optics which is not the case for a diffuser or hologram. Although some minor parasitic diffraction may be associated a phase mask, this is not essential to the invention. In terms of efficiency, the random phase mask method of homogenization is superior to a diffuser. Diffuser homogenizers conventionally used in illuminators rely on a significant reduction of brightness to produce a uniform illumination. Because the random phase mask 150 does not rely on diffraction, the brightness of the source array is essentially preserved.

It is to be noted that example embodiments of the invention may employ multi-source arrays comprising two or more lasers, wherein each of the lasers is an individual laser beam. Alternatively, each of the two or more sources may each comprise a laser array made up of a plurality of laser elements. Further, alternative embodiments of the invention may incorporate a single laser array comprising a plurality of lasers. Accordingly, laser arrays that are laser diode arrays will be made up of a plurality of laser diodes. Laser arrays other than laser diode arrays may also be employed as a source. For example the arrays may be formed using a plurality of fiber coupled laser diodes with the fiber tips held in spaced apart relation to each other, thus forming an array of laser beams. The output of such fibers may likewise be coupled into a light pipe and scrambled to produce a homogeneous illumination line. In another alternative, the fibers could also be a plurality of fiber lasers with outputs arrayed in fixed relation. Preferred embodiments of the invention employ infrared lasers. Infrared diode laser arrays employing 150 pm emitters with total power output of around 50 W at a wavelength of 830 nm, have been successfully used in the present invention. It will be apparent to practitioners in the art that alternative lasers including visible light lasers are also employable in the present invention.

Conveniently, the light pipe 20 can be produced using a pair of reflective mirrors as described herein, but this is not mandated. The light pipe can also be fabricated from a transparent glass solid that has opposing reflective surfaces for reflecting the laser beams. A suitable solid can have parallel and/or non-parallel surfaces. Light pipe surfaces can be coated with a reflective layer or the light pipe 20 may rely on total internal refraction to channel the laser beams toward the output end of the light pipe 20.

Finally, the optical path from the output end to the light valve has been shown to lie substantially along the system plane. Alternate embodiments of the invention may employ one or more optical elements such as mirrors between the light pipe and the light valve so as to permit the positioning of the light valve on a plane offset from the system plane or to position the light valve on a plane that is at an angle to the system plane. These alternate positions of the valve, may advantageously allow for a more compact imaging system.

As will be apparent to those skilled in the art in light of the foregoing disclosure, many alterations and modifications are possible in the practice of this invention without departing from the scope thereof.

### PARTS LIST

10 laser array
12 laser array
14 emitters
16 microlens
18 central axis
20 light pipe
22 reflecting surface
24 input end
26 output end
28 cylindrical lens
29 aperture
30 spherical lens
32 cylindrical lens
34 light valve
36 modulator sites
40a radiation beam
40b radiation beam
40c radiation beam
42b output radiation beam
42c composite illumination beam
42d beams
44 point
46 line
60 beam
62 beam
66 point
68 point
72 point
74 point
100 sharp feature
100A trough sharp feature
100B peak sharp feature
110 mirror
112 point source
114 point source
116 point source
118 point source
122 virtual image
124 virtual image
126 virtual image
128 virtual image
130 multi-source array
140 illuminated surface
150 random phase mask
160 optical elements
170 shaded area
180 unshaded area

1. An apparatus for illuminating a light valve, comprising:
at least one laser array capable of emitting a plurality of radiation beams, each radiation beam propagating at least along a first axis;
a light pipe comprising:
at least two reflecting surfaces, the two reflecting surfaces being spaced apart and opposing each other to reflect light therebetween along the first axis;
an input end separation between the two planar reflecting surfaces, the input end separation positioned to receive the plurality of radiation beams;
an output end separation between the two reflecting surfaces positioned to emit an output radiation;
at least one optical element located downstream of the output end separation, the at least one optical element operable for illuminating the light valve by imaging a portion of the output radiation onto the light valve; and
a random phase mask operable for creating a substantially uniform illumination profile in the output radiation.

2. The apparatus of claim 1, wherein the random phase mask comprises a plurality of surfaces, at least one of the surfaces being arranged to intercept at least one radiation beam, and selectively impart a phase shift on the at least one radiation beam.

3. The apparatus of claim 2, wherein the plurality of surfaces impart different phase shifts to each of the plurality of radiation beams.

4. The apparatus of claim 2, wherein the plurality of surfaces impart a phase shift on a first radiation beam and do not impart a phase shift on a second radiation beam.

5. The apparatus of claim 4, wherein the at least one of the surfaces imparts a one half wave phase shift on the first radiation beam.

6. The apparatus of claim 1, wherein the random phase mask comprises areas of different optical thickness.

7. The apparatus of claim 1, wherein the random phase mask is comprised of etched and unetched areas.

8. The apparatus of claim 1, wherein the random phase mask is at least ten times the wavelength of radiation beams.

9. The apparatus of claim 1, wherein the random phase mask is positioned upstream of the output end separation.

10 The apparatus of claim 1, wherein the random phase mask is positioned between the input end separation and the output end separation.

11. The apparatus of claim 1, comprising at least one optical element positioned between the at least one laser array and the input end separation.

12. The apparatus of claim 11, wherein the at least one optical element comprises a cylindrical lens.

13. The apparatus of claim 11, wherein the at least one optical element comprises an anamorphic optical element.

14. A method for selecting a of a random phase mask mosaic pattern for use in an illumination system comprising an array of radiation sources operable for irradiating the random phase mask and a light pipe with a plurality of radiation beams to generate an output radiation at an output end of the light pipe, the method comprising:
generating a first mosaic pattern and a second mosaic pattern, each of the patterns defining a plurality of elements operable for imparting different phases on the plurality of radiation beams;
generating an intensity profile of output radiation for each of the first and second phase mosaic patterns;
comparing the uniformity of each of the intensity profiles; and
selecting either the first mosaic pattern or the second mosaic pattern on the basis of the best intensity profile uniformity.

15. The method of claim 14, comprising selecting either the first mosaic pattern or the second mosaic pattern on the basis that an entendue of the output radiation is greater than or equal to 95%.
